(19) United States
(12) Patent Application Publication
(10) Pub. No.: US 2007/0207550 A1
(43) Pub. Date: Sep. 6, 2007

(54) Accuracy improvement in blood gas testing

(76) Inventors: Amar Pal Singh Rana, Sunnyvale, CA (US); Sam Pal Rana, Sunnyvale, CA (US)

Correspondence Address: Dr. Amar Pal Singh RANA, P.O. Box 2279, Sunnyvale, CA, 94087, US

(21) Appl. No.: 11/364,623

(22) Filed: Mar. 1, 2006

(51) Int. Cl. G06F 19/00; G01N 31/00

(52) U.S. Cl. 436/127; 702/22

(57) ABSTRACT

An improved bicarbonate determination with variability of apparent dissociation constant in Henderson-Hasselbach equation or Henderson equation with Henry's law is described. The improved bicarbonate is utilized in the determination of improved Base Excess, Base Deficit or Buffer Base for blood gas testing.

### BACKGROUND OF THE INVENTION

1. Technical Field

The present invention pertains to an improved bicarbonate determination with variability of apparent dissociation constant in Henderson-Hasselbach equation or Henderson equation with Henry's law. The improved bicarbonate is utilized in the determination of improved Base Excess (BE), Base Deficit (BD) or Buffer Base (BB) for blood gas testing. Base deficit is negative of base Excess value or base excess is negative value of base deficit value.

2. Description of the Related Art

Hasselbach and Gammeltoft and Hasselbach adopted the Sorenson convention (where [H⁺] is expressed by pH), and presented the well-known “the Henderson-Hasselbach equation” as:
pH=pK′+log [HCO₃^{-]/(Sco}₂.Pco₂) (Eq. 1)
where the total CO₂ concentration in expressed as Henry's law, [CO₂]=Sco₂*Pco₂ where Sco₂ (the solubility coefficient of CO₂ in plasma, a constant) and Pco₂ (the partial pressure of CO₂ in plasma) and pK′ is a constant. Equation 1 can also be expressed as in non-logarithmic form with K₁′=Sco₂*10^{-pK′} as:
[H⁺]=K₁′.Pco₂/[HCO₃⁻] (Eq. 2)

We show the effect of pK′ variability on [HCO3-] calculation utilizing equation 1 when pK′ is varied from 5.9 to 6.4 for both fixed pH=7.4 and Pco₂ =40 mmHg is shown in Table-1. The large variation of the [HCO₃⁻] for very small variations in pK′ may be noted. The logarithmic function hides the variations and [HCO₃⁻] calculations requires anti-log and brings forth the large variation in the [HCO₃⁻].

TABLE 1
Variation of [HCO₃⁻], Base Excess (equation 11)
when pK′ is varied from 5.9 to 6.4 for
both fixed pH = 7.4 and Pco₂ = 40 mmHg

| pK′ | [HCO₃⁻] | Base Excess |
|---|---|---|
| 5.9 | 38.83 | 13.4 |
| 6.0 | 30.85 | 5.99 |
| 6.1 | 24.50 | 0.09 |
| 6.2 | 19.46 | −4.59 |
| 6.3 | 15.46 | −8.3 |
| 6.4 | 12.28 | −11.26 |

U.S. Pat. No. 6,167,412 issued to Simon on Dec. 26, 2000 entitled, “Handheld medical calculator and medical reference device” describes a handheld calculator without any calculations for Henderson-Hasselbach equation solution with variability of pK′ or K₁ or K₁′ or Base-Excess with bicarbonate variability of pK′ or K₁ or K₁′.

U.S. Pat. No. 4,454,229 issued to Zander et. al on Jun. 12, 1984 entitled, “Determination of the acid-base status of blood” describes base excess determination at carbon dioxide partial pressure at 0 torr and photometric determination of pH and no mention of bicarbonate or base excess variability due to pK′ or K₁ or K₁′.

U.S. Pat. No. 4,384,586 issued to Christiansen et. al on May 24, 1983 entitled, “Method and apparatus for pH recording” describes continuous or intermittent monitoring of in vivo pH of a patient's blood or plasma without any mention of bicarbonate or base excess variability due to pK′ or K₁ or K₁′.

### SUMMARY OF THE INVENTION

There exists a need for improvement in the accuracy in blood gas testing. It is an object of this invention to improve the accuracy of bicarbonate or HCO3⁻ determination in blood gas testing. It is an object of this invention to improve the accuracy of bicarbonate or HCO3⁻ determination in base excess, base deficit or buffer base. It is also an object of this invention to improve the accuracy of blood gas testing without increasing health care costs

### DETAILED DESCRIPTION OF THE INVENTION

In one aspect of our invention, we utilize S_{CO2} and pK′ values for bodily fluids which are dependent on ionic strength, protein concentration, etc. in computing Base excess from equations 7, 9 or 11 by substituting for [HCO₃⁻] from equation 1 into equations 7 and 11 and utilizing pK′ values from equation 4 or by substituting for pK′ from equation 4 into equation 9 at 37° C. Heisler developed complex equations for S_{CO2} (mmol l-1 mmHg-1) (1 mmHg=133.22 Pa) and pK′ that are purported to be generally applicable to aqueous solutions including body fluids between 0° and 40° C. and incorporate the molarity of dissolved species (Md), solution pH, temperature (T, ° C.), sodium concentration ([Na⁺], mol l-1), ionic strength of non-protein ions (I, mol l-1) and protein concentration ([Pr], g l-1) and are also referenced by Stabenau and Heming but not utilized for BE calculation:
S_{CO2}=0.1008−2.980×10−2Md+(1.218×10−3Md−3.639×10−3)T−(1.957×10−5Md−6.959×10−5)T2+(7.171×10−8Md−5.596×10−7)T3. (Eq. 3)
pK′=6.583−1.341×10−2T+2.282×10−4T2−1.516×10−6T3−0.341I0.323−log {1+3.9×10−4[Pr]+10A(1+10B)}, (4) where A=pH−10.64+0.011T+0.737I0.323 and B=1.92−0.01T−0.737I0.323+log [Na⁺]+(0.651−0.494I)(1+0.0065[Pr]) (Eq. 4)
Equation 4 may also be expressed in the form of table, graph, curve, algorithm, nomogram or curve nomogram and may also be programmed into a computer or microprocessor.

In another aspect of our invention, we directly measure [HCO₃⁻] for fast and high volume blood testing typically utilizing Ion-Selective Electrodes (ISE) in electro-chemical sensor based analytical measurements and include the directly measured [HCO₃⁻] into the calculation for base excess, base deficit or buffer base utilizing equations 7 or 11.

In yet another aspect of our invention we utilize our corrected-BE incorporating variation of K₁′ as K₁′ versus BE (equation 5), corrected for ionic strength, etc. by combining Van Slyke equation according to Siggaard-Anderson or Zander or simplified-Zander

While both Sco₂ and pK′ in equation 1 are not constants and vary with ionic strength, temperature, pH and protein concentration, etc. the variation of pK′ is considerable with temperature and ionic strength. With K₁′=Sco₂*10^{-pK′}, Sco₂ is taken to be reasonably constant at 0.03 mmol/L.mmHg at 37° C. Once the temperature is fixed at 37° C., pK′ still varies strongly with ionic strength. Hyponatraemia is fairly common and may vary over a range of 80 to 210 mmol/1 in plasma Na levels. Abnormal plasma Na-levels fluctuations over hours and days in a given patient are not uncommon. Hyponatraemia or hypernatraemia i.e. variation in Plasma Na levels contributes significantly to variations in K₁′ or pK′. We find the variation in pK′ with ionic strength is particularly evident if logarithmic scale is not used as in K₁′ as expressed in equation 5. Such large corrections are very obvious when applied to BE model, since calculation of bicarbonate from equation 2 in Base Excess approach also includes taking the antilog and thus one is confronted by the high level of variations due to pK′. We converted the data in the literature from Hastings and Sendroy data from pK′ versus ionic strength to K₁′ versus BE when only bicarbonate and strong ions are present and find it to be:
K₁′=2.7346.10⁻¹¹−0.3692.10⁻¹¹.BE (Eq. 5)

It is further noteworthy, as per the electrical neutrality equation 6, that all the ions are inter-related to reach equilibrium:
([Na⁺]+[K⁺]+ . . . −[Cl⁻]−[ketones]−[lactates] . . . )+[H⁺]−[HCO₃⁻]−[A⁻]−[CO₃⁻²]−[OH⁻]=0 (Eq. 6)
where [A⁻] represents the albumin ions.

It may be noted that pK′ could be utilized in equation 5 as a function of BE. We start with Van Slyke equation according to Siggaard-Anderson and incorporate our correction for K₁′(or pK′) variations with cHCO3⁻ as the bicarbonate concentration:
ctH⁺-Siggaard-Andersen(=BE-Siggaard-Anderson)=−(1−(1−rc)·φEB)·((cHCO3⁻−cHCO3°)+bufferval·(pH−pH°)) (Eq. 7)
rc=cHCO3⁻E/cHCO3⁻P=0.57
φEB=ctHbB/ctHbE
ctHbE=21 mM
cHCO3°=24.5 mM
pH°=7.40
bufferval=βmHb·ctHb+βP
βmHb=2.3
   If the albumin concentration (cAlb) is known, the buffer value of non-bicarbonate buffers in plasma may be expressed as a function of cAlb:
βP=βP°+βmAlb·(cAlb−cAlb°)
βP°=7.7 mM
βmAlb=8.0
cAlb°=0.66 mM
   ctH⁺Ecf is calculated using ctHbEcf=ctHbB·FBEcf·FBEcf, volume fraction of blood in extended extracellular fluid (red blood cells and 2 parts of plasma diluted blood), is 0.33 by default.
   The first term (1−ctHb/ctHbb) is an empirical factor which takes the distribution of HCO3⁻ between plasma and erythrocytes into account. The second term (cHCO3⁻−cHCO3°) titrates the bicarbonate buffer to pH=7.40 at pCO2=5.3 kPa. The last term titrates the non-bicarbonate buffers (primarily Hemoglobin (Hb) and albumin) to pH=7.40.
   We combine equations 5 and 7 to obtain equation 8 to obtain the corrected Siggaard-Anderson's Van Slyke equation for corrected BE:
   corrected-ctH⁺-Siggaard-Andersen(=corrected-BE-Siggaard-Anderson)=−(1−(1−rc)·φEB)·(((2.7346/2.46)cHCO3⁻−cHCO3°)+bufferval·(pH−pH°))/(1+(1−(1−rc)·φEB).0.3692.pco2.10^{(pH-8)}) (Eq. 8)

For clinical purposes, the Van Slyke equation according to Zander is the good choice and can be recommended in the following form:
BE-Zander=(1−0.0143.cHb).[{0.0304.P_{CO2}.10^{pH-pK′}−24.26}+(9.5+1.63.cHb). (pH−7.4)]−0.2.cHb.(1−sO₂) (Eq 9)
where the last term is a correction for oxygen saturation (sO₂). Hence, base excess can be obtained with high accuracy (<1 mmol/l) from the measured quantities of pH, pCO₂, cHb, and sO₂ in used and cHb is Hemoglobin concentration.
We combine equation 5 and 9 to obtain equation 10 for corrected BE for Zander's Van Slyke equation:
corrected-BE-Zander=(1−0.0143.cHb). [{2.7346.P_{CO2}.10^{(pH-8)}−24.26}+(9.5+1.63.cHb).(pH−7.4)]−0.2.cHb.(1−sO₂)/(1+(1−0.0.0143.cHb).0.3692.pco2.10^{(pH-08)}) (Eq. 10)

For purpose of illustration of our pragmatic approach, we utilized a simplified Siggaard-Anderson's Van Slyke equation:
BE-simplified-zander=0.9287(HCO₃−24.4+14.83(pH−7.4)) (Eq. 11)
We combine equations 5 and 11 to obtain equation 12 for corrected BE
corrected-BE-simplified-Zander=0.9287((2.7346.10⁻⁰⁸.pco2/10^{-pH})−24.4+14.83(pH−7.4))/(1+0.9287.0.3692.pco2.10^{(pH-8)}) (Eq. 12)

The above mentioned equation can be programmed into a computer or microprocessor. The following definitions are also utilized:
Buffer Base (BB): Indicates the concentration of buffer anions in the blood when all hemoglobin is present as HbO2.
Normal Buffer Base (NBB): Is the buffer base value of blood with pH 7.4, Pco₂ 40 mm Hg and temperature 37° C.
NBB=41.7+0.68.times.Hb mmol/liter.
Actual Buffer Base (ABB): Buffer Base value at actual oxygen saturation (is only used as a calculating quantity).
ABB=BB+0.31.times.Hb (1-Sat) mmol/liter.
Besides, the following relations exist between the above-mentioned quantities:
BE+BB−NBB=BB−(41.7+0.68.times.Hb) mmol/liter.
ABE=BE+0.31.times.Hg (1-Sat) mmol/liter where Sat is the oxygen saturation.
ABB−ABE=NBB mmol/liter.

### BRIEF DESCRIPTION OF THE DRAWINGS

FIG. 1 shows the improvements of our invention for BE for pK′=6.1 (assumed constant), BE-simplified-Zander for the measured data points with know pK′ and improved BE-simplified-Zander corrected for pK′ variability by absorbing pK′ (or K₁′) versus exact-BE into the BE-simplified-Zander calculations.

### BRIEF DESCRIPTION OF THE DRAWINGS

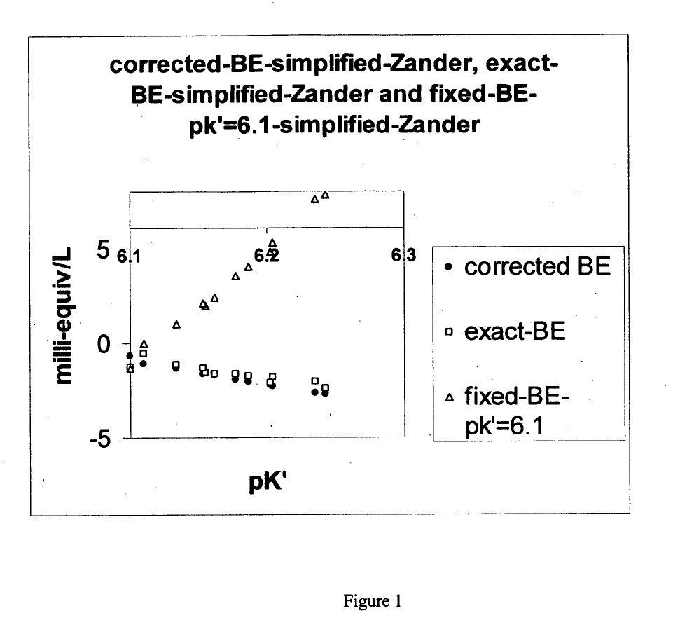

FIG. 1 shows the fixed-BE for pK′=6.1 (assumed constant), exact-BE-simplified-Zander for the measured data points and corrected-BE-simplified-Zander corrected for pK′ variability by absorbing pK′ (or K₁′) versus exact-BE into the BE-simplified-Zander calculations. Note the improvement of corrected-BE-simplified-Zander over fixed-BE for constant pK′=6.1. The x-axis reflects various data points shown as pK′ values.

To measure ionic strength requires, depending upon the precision to which one aspires, the measurement of ion concentrations including Na⁺, Cl⁻, K⁺, Ca⁺⁺, Mg⁺⁺, sulfate, urate, and lactate with their attendant costs. The problem of cumulative random assay error with so many measured parameters is not trivial and may compromise the very precision needed to directly correct pK′ or K₁′. This approach makes an improvement in a cost effective manner by absorbing the variation of K₁′ or pK′ as a function of BE itself without having resort to costly and error prone measurements of the Na+, ionic strength, etc. there by reducing health care costs.

It should be understood that the foregoing description is only illustrative of the invention. Various alternatives and modifications can be devised, without departing from the spirit and scope of the invention.

What is claimed is:

1. A method of improved base excess, base deficit or buffer base determination of a fluid comprising
Van Slyke equation and
Henderson-Hasselbach equation or
Henderson equation and Henry' law and
bicarbonate or HCO₃⁻, H⁺, albumin, hemoglobin and derivatives, globulin and derivatives, weak proteins, organic and inorganic phosphates, sulphate, carbonate, keto and lactate ions or metabolites
at a fixed temperature

2. A method of improved base excess, base deficit or buffer base determination of a fluid as in claim 20 wherein said bicarbonate or HCO₃⁻is determined by
said Henderson-Hasselbach equation: pH=pK′+log [HCO₃⁻](Sco₂.Pco₂)
wherein Sco₂ is the solubility coefficient, Pco₂ is the partial pressure of carbon dioxide, pH is −log [H³⁰ ], [H⁺] is the H⁺ion concentration, [HCO₃⁻] is bicarbonate ion concentration and pK′ is a variable or
or said Henderson equation: [H⁺]=K₁*[CO₂]/[HCO₃⁻], with said Henry law: [CO₂]=Sco₂*Pco₂, becomes [HCO3⁻]=K₁′*[Pco₂]/[H^{+]}
wherein [CO2] is the carbon dioxide concentration, [H⁺] is the H⁺ion concentration, [HCO₃⁻] is bicarbonate ion concentration, K₁ is a variable, Sco₂ is the solubility coefficient, Pco₂ is the partial pressure of carbon dioxide and K₁′ is a variable.
at a said fixed temperature

3. A method of improved base excess, base deficit or buffer base determination of a fluid as in claim 1 wherein measured value of said bicarbonate or said HCO₃⁻ is utilized.

4. A method of improved base excess, base deficit or buffer base determination of a fluid as in claim 1 wherein measured value of said bicarbonate or said HCO₃⁻ utilizing ion sensing electrode responsive only to said bicarbonate or said HCO₃⁻.

5. A method of improved base excess, base deficit or buffer base determination of a fluid as in claim 1 wherein calculated value said bicarbonate is obtained from said Henderson equation with said variable K₁.

6. A method of improved base excess, base deficit or buffer base determination of a fluid as in claim 1 wherein calculated value said bicarbonate is obtained from said Henderson equation and said Henry's law with said variable K₁′.

7. A method of improved base excess, base deficit or buffer base determination of a fluid as in claim 1 wherein said variable K1 or K₁′ value is obtained from a table, equation, graph, curve, algorithm, nomogram or curve nomogram of said K₁′ as function of at least one of a plurality of ionic strength, sodium, protein, pH, albumin, globulin, hemoglobin, inorganic and organic phosphate, keto metabolites, lactic metabolites, weak protein concentrations and temperature.

8. A method of improved base excess, base deficit or buffer base determination of a fluid as in claim 1 wherein calculated value said bicarbonate is obtained from said Henderson-Hasselbach equation with said variable pK′.

9. A method of improved base excess, base deficit or buffer base determination of a fluid as in claim 1 wherein said variable pK′ value is obtained from a table, equation, curve, graph, curve, algorithm, nomogram or curve nomogram of said pK′ as function of at least one of a plurality of ionic strength, sodium, protein, pH, albumin, globulin, hemoglobin, inorganic and organic phosphate, keto, lactic metabolites, weak proteins concentrations and temperature.

10. A method of improved base excess, base deficit or buffer base determination of a fluid as in claim 1 wherein said calculation is performed at or interpolated or extrapolated to said fixed temperature in the range of 30 to 45 degrees Celsius.

11. A method of improved base excess, base deficit or buffer base determination of a fluid as in claim 1 wherein said fluid is human blood, urine, plasma, saliva, spinal fluid, serum or blood diluted by one to five times the volume of the said same blood plasma.

12. A method of improved base excess, base deficit or buffer base determination of a fluid as in claim 1 wherein said variable pK′ or said K₁ or said K₁′ is a function of strong ion difference.

13. A computer implemented system for performing improved base excess, base deficit or buffer base calculation for a fluid, the system having a processor and a memory coupled via a bus, the memory containing computer readable instructions which when executed by the processor cause the system to implement a method comprising:
Van Slyke equation and
Henderson-Hasselbach equation: pH=pK′+log [HCO₃⁻]/(Sco₂.Pco₂) wherein Sco₂ is
the solubility coefficient, Pco₂ is the partial pressure of carbon dioxide, pH is −log [H⁺], [H⁺] is the H⁺ ion concentration, [HCO₃⁻] is bicarbonate ion concentration and pK′ is a variable or
Henderson equation: [H⁺]=K₁*[CO₂]/[HCO₃⁻], with said Henry law: [CO₂]=Sco₂*Pco₂, becomes [HCO3⁻]=K₁′*[Pco₂]/[H⁺]
wherein [CO2] is the carbon dioxide concentration, [H⁺] is the H⁺ ion concentration, [HCO₃⁻] is bicarbonate ion concentration, K₁ is a variable, Sco₂ is the solubility coefficient, Pco₂ is the partial pressure of carbon dioxide and K₁′ is a variable or
measured value of said bicarbonate or said HCO₃⁻ is utilized or
wherein variable K₁, K₁′ or pK′ value is obtained from a table, equation, graph or curve of said K₁′ as function of at least one of a plurality of ionic strength, sodium, protein, pH, albumin, globulin, hemoglobin, inorganic and organic phosphate, keto metabolites, lactic metabolites, weak protein concentrations and temperature or
said variable pK′ or said K₁ or said K₁′ is a function of Base excess, Buffer Deficit or Buffer Base and
said fluid is human blood, urine, plasma, saliva, spinal fluid, serum or blood diluted by one to five times the volume of the said same blood plasma and
H⁺, pH, albumin, hemoglobin and derivatives, globulin and derivatives, weak proteins, organic and inorganic phosphates, sulphate, carbonate, keto and lactate ions or metabolites and
at a fixed temperature in the range of 30 to 45 degrees Celsius.

14. A method of improved bicarbonate or HCO₃⁻ determination in a fluid comprising:
said Henderson-Hasselbach equation: pH=pK′+log [HCO₃⁻]/(Sco₂.Pco₂)
wherein Sco₂ is the solubility coefficient, Pco₂ is the partial pressure of carbon dioxide, pH is −log [H⁺], [H⁺] is the H⁺ ion concentration, [HCO₃⁻] is bicarbonate ion concentration and pK′ is a variable or
or said Henderson equation: [H⁺]=K₁*[CO₂]/[HCO₃⁻], with said Henry law: [CO₂]=Sco₂*Pco₂, becomes [HCO3⁻]=K₁′*[Pco₂]/[H⁺]
wherein [CO2] is the carbon dioxide concentration, [H⁺] is the H⁺ ion concentration, [HCO₃⁻] is bicarbonate ion concentration, K₁ is a variable, Sco₂ is the solubility coefficient, Pco₂ is the partial pressure of carbon dioxide and K₁′ is a variable.
at a said fixed temperature in the range of 30 to 45 degrees Celsius.

15. A method of improved bicarbonate or HCO₃⁻ determination in a fluid as in claim 14 wherein said variable K₁ or K₁′ value is obtained from a table, equation, graph or curve of said K₁ or K₁′ as function of at least one of a plurality of ionic strength, sodium, protein, pH, albumin, globulin, hemoglobin, inorganic and organic phosphate, keto metabolites, lactic metabolites, weak protein concentrations and temperature.

16. A method of improved bicarbonate or HCO₃⁻ determination as in claim 14 wherein said variable pK′ value is obtained from a table, equation or curve or graph of said pK′ as function of at least one of a plurality of ionic strength, sodium, protein, pH, albumin, globulin, hemoglobin, inorganic and organic phosphate, keto, lactic metabolites, weak proteins concentrations and temperature.

17. A method of improved bicarbonate or HCO₃⁻ determination as in claim 14 wherein said fluid is human blood, urine, plasma, saliva, spinal fluid, serum or blood diluted by one to five times the volume of the said same blood plasma.
